(19) United States
(12) Patent Application Publication
(10) Pub. No.: US 2024/0314828 A1
(43) Pub. Date: Sep. 19, 2024

(54) CONTROL PLANE ACTIVITY BETWEEN WIRELESS DEVICE AND WIRELESS NETWORK

(71) Applicant: Nokia Technologies Oy, Espoo (FI)

(72) Inventors: Mads LAURIDSEN, Aalborg (DK); Lars DALSGAARD, Oulu (FI); Frank FREDERIKSEN, Aalborg (DK); Jorma Johannes KAIKKONEN, Oulu (DK); Karol SCHOBER, Espoo (FI)

(21) Appl. No.: 18/260,911

(22) PCT Filed: Dec. 3, 2021
(86) PCT No.: PCT/EP2021/084098

§ 371 Date: Jul. 10, 2023

(30) Foreign Application Priority Data
Jan. 12, 2021 (FI) 20215026

(51) Int. Cl. H04W 72/542; H04W 72/04; H04W 72/232

(52) U.S. Cl. CPC H04W 72/542; H04W 72/04; H04W 72/232

(57) ABSTRACT

There is provided receiving, by a wireless device, from a wireless network, a configuration for at least one control plane activity towards the wireless network; and transmitting, by the wireless device, on the basis of determining that one or more conditions for changing the transmission activity are met, assistance information for the at least one control plane activity, to the wireless network.

### TECHNICAL FIELD

The present invention relates to control plane activity between a wireless device and a wireless network.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

5G-NR (5th generation New Radio) is a new radio access technology which has been developed by the 3rd generation partnership project (3GPP) for the 5th generation mobile networks. 5G-NR has been specified within 3GPP to be able to coexist with 4G-LTE (Long Term Evolution) within the same spectrum. In 5G systems a mobile communication device, which may also be called as a user equipment (UE), may be configured to apply discontinuous reception (DRX). DRX is a mechanism in which UE gets into sleep mode for a certain period of time and wake up for another period of time. When the UE enters the sleep mode it is can save power by not monitoring a Physical Dedicated Control Channel (PDCCH) for any data destined to the UE. On the other hand, when the UE is wake up, receiver of the UE is on and it can receive and check Physical Dedicated Control Channel (PDCCH) for any data destined to the UE. Accordingly, the power consumption of the UE is higher during a DRX Active Time, when the UE is awake. According to 3GPP TS 38.321 V16.2.1 (2020-09), Medium Access Control (MAC) protocol specification, the DRX Active Time includes a time during which:
a) drx-onDurationTimer or drx-InactivityTimer or drx-RetransmissionTimerDL or drx-RetransmissionTimerUL or ra-ContentionResolutionTimer (as described in Section 5.1.5 of 38.321) is running; or
b) a Scheduling Request is sent on Physical Uplink Control Channel (PUCCH) and is pending (as described in Section 5.4.4 of 38.321); or
c) a PDCCH indicating a new transmission addressed to the cell Radio Network Temporary Identifier (C-RNTI) of the Medium Access Control (MAC) entity has not been received after successful reception of a Random Access Response for the Random Access Preamble not selected by the MAC entity among the contention-based Random Access Preamble (as described in Section 5.1.4 of 38.321).

The UE can be configured to perform uplink transmissions related a number of control plane activities. The control plane activities may comprise uplink and channel estimation activities. In downlink channel estimation, when the UE has measured downlink Channel State Information (CSI) Reference Signals (CSI-RS) it will report the result to the network using the CSI-ReportConfig, or CSI report, described in Section 6.3.1 of 3GPP TS 38.331 V16.2.0 (2020-09), Radio Resource Control (RRC) protocol specification. The reporting may be periodic (PUCCH), semi-persistent (PUCCH or Physical Uplink Shared Channel (PUSCH)), or aperiodic (PUSCH). The report may contain information on e.g. Channel Quality Indicator (CQI), rank indicator, precoding matrix indicator, and/or Reference Signal Received Power (RSRP).

In uplink channel estimation, the UE may transmit Sounding Reference Signals (SRS) in uplink. The SRS is used for uplink scheduling by the network and configured using the Information Element (IE) SRS-Config in Section 6.3.2 of the 3GPP TS 38.331. Similar to the CSI report, the SRS can be aperiodic, periodic, and semi-persistent. The SRS transmission is configured for a set of resources in the time-frequency domain (with a certain periodicity and offset in time for the periodic and semi-persistent transmissions).

Therefore, the control plane activities limit possibilities to reduce power consumption of the UE.

### SUMMARY

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect there is provided a method comprising:
receiving, by a wireless device, from a wireless network, a configuration for at least one control plane activity comprising a transmission activity towards the wireless network;
transmitting, by the wireless device, on the basis of determining that one or more conditions for changing the transmission activity are met, assistance information for the at least one control plane activity, to the wireless network.

According to a second aspect there is provided a method comprising:
transmitting, by a wireless network, to a wireless device, a configuration for at least one control plane activity towards the wireless network;
receiving, by the wireless network, from the wireless device, assistance information for the at least one control plane activity;
determining, by the wireless network, on the basis of the received assistance information a need to change the at least one control plane activity; and
if the received assistance information indicates a need to change the at least one control plane activity, transmitting, by the wireless network, to the wireless device, on the basis of the determined change in response to receiving the assistance information, at least one of
a new configuration for the at least one control plane activity, and
a downlink signaling indicating an uplink transmission allocation for the wireless device, the downlink signaling comprising Downlink Control information (DCI) for triggering a Physical Uplink Shared Channel (PUSCH) transmission without data and channel state information (CSI).

According to a third aspect there is provided an apparatus comprising:
means for receiving, from a wireless network, a configuration for at least one control plane activity towards the wireless network;
means for transmitting, on the basis of determining that one or more conditions for changing the transmission activity are met, assistance information for the at least one control plane activity, to the wireless network.

According to a fourth aspect there is provided an apparatus comprising:
means for transmitting, to a wireless device, a configuration for at least one control plane activity towards the apparatus;
means for receiving from the wireless device, assistance information for the at least one control plane activity.

According to a fifth aspect there is provided an apparatus comprising:
one or more processors, and memory storing instructions that, when executed by the one or more processors, the apparatus is caused to:
receive, from a wireless network, a configuration for at least one control plane activity towards the wireless network;
transmit, on the basis of determining that one or more conditions for changing the transmission activity are met, assistance information for the at least one control plane activity, to the wireless network.

According to a sixth aspect there is provided an apparatus comprising:
one or more processors, and memory storing instructions that, when executed by the one or more processors, the apparatus is caused to:
transmit, to a wireless device, a configuration for at least one control plane activity towards the apparatus;
receive from the wireless device, assistance information for the at least one control plane activity.

According to a seventh aspect there is provided a computer program comprising computer readable program code means adapted to perform at least the following:
receiving, by a wireless device, from a wireless network, a configuration for at least one control plane activity towards the wireless network;
transmitting, by the wireless device, on the basis of determining that one or more conditions for changing the transmission activity are met, assistance information for the at least one control plane activity, to the wireless network.

According to an eight aspect there is provided a computer program comprising computer readable program code means adapted to perform at least the following:
transmitting, by a wireless network, to a wireless device, a configuration for at least one control plane activity towards the wireless network:
receiving, by the wireless network, from the wireless device, assistance information for the at least one control plane activity.

At least some embodiments provide that control plane activity can be adapted for enhancing possibilities to reduce power consumption of a wireless device involved in a control plane activity.

### BRIEF DESCRIPTION OF THE DRAWINGS

For a more complete understanding of example embodiments of the present invention, reference is now made to the following descriptions taken in connection with the accompanying drawings in which:

FIG. 1 shows a part of an exemplifying wireless communications access network in accordance with at least some embodiments of the present invention;

FIG. 2 shows a block diagram of an apparatus in accordance with at least some embodiments of the present invention;

FIG. 3 shows an apparatus in accordance with at least some embodiments of the present invention;

FIG. 4 shows an example of an arrangement for wireless communications comprising a plurality of apparatuses, networks and network elements;

FIGS. 5, 6 and 7 illustrate examples of methods in accordance with at least some embodiments of the present invention;

FIG. 8 illustrates an example of a sequence in accordance with at least some embodiments of the present invention; and

FIGS. 9 and 10 illustrate examples of block diagrams of apparatuses in accordance with at least some embodiments of the present invention.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Control plane activity may comprise at least one of channel state information reporting, uplink sounding, power headroom reporting, reference signal received power reporting and buffer status reporting. The control plane activity may comprise a transmission activity from a wireless device to a wireless network, i.e. uplink transmissions. The wireless device may perform at least one of a measurement activity and a monitoring activity for the at least one control plane activity. Examples of the measurement activity comprise at least CSI-RS measurements. Examples of the monitoring activity comprise at least monitoring for downlink control information (DCI) addressed to the wireless device. The DCI may be carried on a Physical Downlink Control Channel (PDCCH). The uplink transmissions may be periodical transmissions from the wireless device to the wireless network. The control plane activity may involve control plane protocol entities hosted at the wireless device and at the wireless network for carrying out functionalities of the control plane activity. The control plane protocol may be a Radio Resource control (RRC) protocol. The control plane activity may be configured by communications of a control plane protocol configuration message from the control plane protocol entity of the wireless network to the control plane protocol entity of wireless device. The wireless device may be configured based on the control plane configuration message to perform uplink transmissions to the wireless network. The channel state information report may be a CSI report. The sounding reference signal may an SRS. The power headroom reporting may be configured by IE PHR-Config in Section 6.3.2. of 3GPP TS 38.331. The power headroom value is the difference between the nominal UE maximum transmit power and an estimated power, e.g. for PUSCH or SRS transmission (see Section 7.7 in 3GPP TS 38.321 for details of PHR report). The periodic power headroom reporting is triggered based on the expiry of the phr-PeriodicTimer. The IE PHR-Config (3GPP TS 38.331) defines the phr-PeriodicTimer, which the UE in case of stationarity could prefer to be changed. The buffer status may be configured by IE BSR-Config in Section 6.3.2. of 3GPP TS 38.331. The buffer status report (BSR) is used by the UE to inform the network about available uplink data (see TS 38.321). The IE BSR-Config (3GPP TS 38.331) defines the periodicBSR-Timer, which defines a periodicity used by the UE to send periodic BSR. The periodic BSR is triggered based on the expiry of the timer and not arrival of UL data in UE buffers. Depending on the data arrival rate the UE could suggest a different periodicity through the UE assistance information. The reference signal received power reporting may comprise a L1-RSRP (Layer 1 Reference Signal received Power) reporting in accordance with Section 5.2.1 of 3GPP TS 38.214.

Mobility of a wireless device may refer to a mobility state of the wireless device determined on the basis of one or more criteria. The mobility state of the wireless device may be determined based on selected metrics and a relation of those metrics to one or more configured criteria. Examples of the criteria comprise Reference Signal Received Power (RSRP) thresholds/offsets. The RSRP thresholds/offsets may be similar to or correspond with RSRP thresholds/offsets for IDLE/Inactive mode in the 3GPP release 16 specifications. It should be note that the change in the mobility state may indicate a change in need for the control plane activity. The mobility state of the wireless device may be stationary, quasi-stationary or mobile. The mobility state may be determined on the basis of a movement of the wireless device. The movement of the wireless device may take place in a service area of a wireless network. The service area of the wireless network may be a cell, a paging area or a routing area for example. The movement of the wireless device may be classified into the different states based on one or more criteria. The criteria may be dependent on implementation. In an example, the criteria may be specific for a control activity between the wireless device and a wireless network. Criteria for the states of movement for a CSI reporting activity may be determined based on CSI of a wireless channel between the wireless device and the wireless network and/or the RSRP thresholds/offsets.

Periodicity of a control plane activity may refer to a time period between transmissions of a wireless device towards a wireless network. the periodicity may be defined based on a configuration of the control plane activity. Increasing the periodicity means that the time period is increased. increasing the periodicity reduces a number of uplink transmissions in a time unit, whereby a transmitted of the wireless device may go into a power saving mode, e.g. to sleep. When the wireless device is configured to apply DRX, DRX Active Time can be reduced, when the periodicity is increased. Decreasing the periodicity means that the time period is decreased. Decreasing the periodicity increase a number of uplink transmissions in a time unit, whereby possibilities for a transmitter of the wireless device to go into a power saving mode, e.g. to sleep, are also reduced. When the wireless device is configured to apply DRX, DRX Active Time can be increased, when the periodicity is reduced. Decreasing the periodicity means that the time period is decreased.

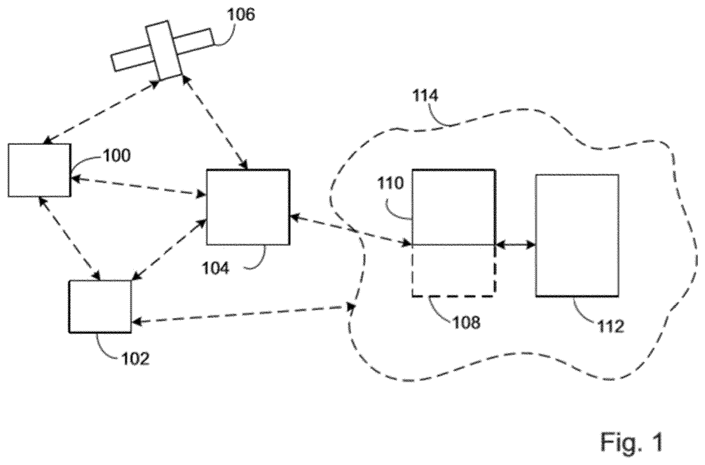

FIG. 1 depicts examples of simplified system architectures showing some elements and functional entities, all being logical units, whose implementation may differ from what is shown. The connections shown in FIG. 1 are logical connections, the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage. The access node provides access by way of communications of radio frequency (RF) signals and may be referred to a radio access node. It should be appreciated that the radio access network may comprise more than one access nodes, whereby a handover of a wireless connection of the user device from one cell of one access node, e.g. a source cell of a source access node, to another cell of another node, e.g. a target cell of a target access node, may be performed.

A communication system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point, access node or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, wireless device, communications device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

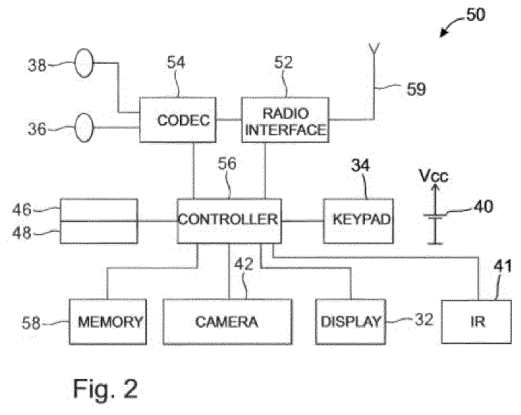

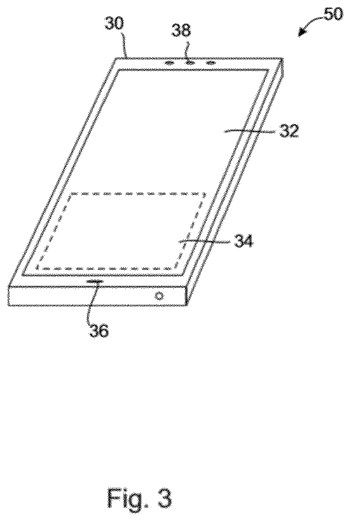

The following describes in further detail suitable apparatus and possible mechanisms for implementing some embodiments. In this regard reference is first made to FIG. 2 which shows a schematic block diagram of an exemplary apparatus or electronic device 50 depicted in FIG. 3, which may incorporate a transmitter according to an embodiment of the invention.

The electronic device 50 may for example be a communications device, wireless device, mobile terminal or user equipment of a wireless communication system. However, it would be appreciated that embodiments of the invention may be implemented within any electronic device or apparatus which may require transmission of radio frequency signals.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The term battery discussed in connection with the embodiments may also be one of these mobile energy devices. Further, the apparatus 50 may comprise a combination of different kinds of energy devices, for example a rechargeable battery and a solar cell. The apparatus may further comprise an infrared port 41 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a universal integrated circuit card (UICC) reader and UICC for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 59 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera 42 capable of recording or detecting imaging.

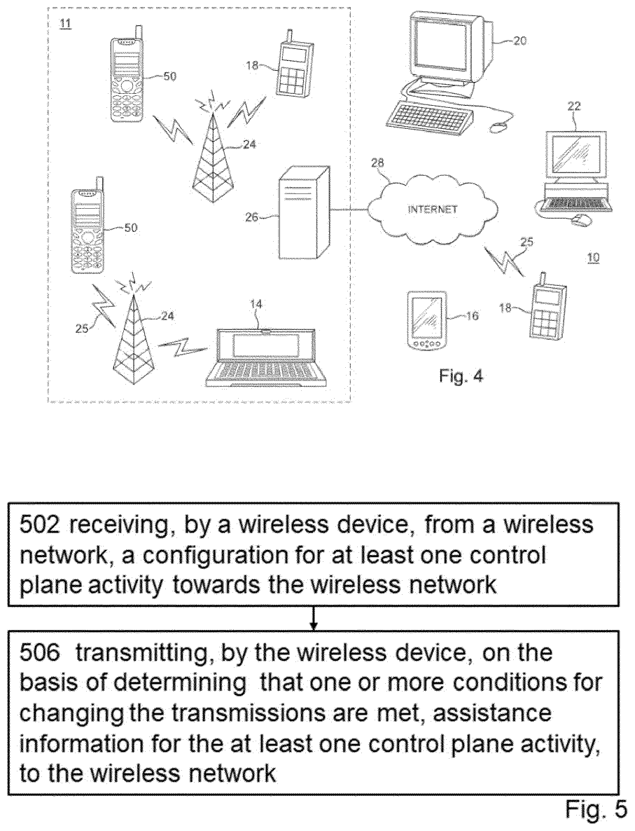

With respect to FIG. 4, an example of a system within which embodiments of the present invention can be utilized is shown. The system 10 comprises multiple communication devices which can communicate through one or more networks. The system 10 may comprise any combination of wired and/or wireless networks including, but not limited to a wireless cellular telephone network (such as a GSM (2G, 3G, 4G, LTE, 5G), UMTS, CDMA network etc.), a wireless local area network (WLAN) such as defined by any of the IEEE 802.x standards, a Bluetooth personal area network, an Ethernet local area network, a token ring local area network, a wide area network, and the Internet.

For example, the system shown in FIG. 4 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22, a tablet computer. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, Long Term Evolution wireless communication technique (LTE), 5G and any similar wireless communication technology. Yet some other possible transmission technologies to be mentioned here are high-speed downlink packet access (HSDPA), high-speed uplink packet access (HSUPA), LTE Advanced (LTE-A) carrier aggregation dual-carrier, and all multi-carrier technologies. A communications device involved in implementing various embodiments of the present invention may communicate using various media including, but not limited to, radio, infrared, laser, cable connections, and any suitable connection. In the following some example implementations of apparatuses utilizing the present invention will be described in more detail.

In an example in accordance with at least some embodiments the communications of the communications devices may comprise uplink transmissions and/or downlink transmissions of data. The uplink transmissions may be performed from a wireless device to the wireless communication system, e.g. an access node, and the downlink transmissions may be performed from the wireless communication system, e.g. an access node, to the wireless device. The uplink transmissions may be performed on an uplink shared channel, e.g. a Physical Uplink Shared Channel (PUSCH). The PUSCH may be transmitted by the wireless device on the basis of a grant received on a downlink control channel, e.g. a Physical Downlink control Channel (PDCCH). The downlink transmissions may be performed on a downlink shared channel, e.g. a Physical Downlink Shared Channel (PDSCH). Release 15 specifications of the 3GPP may be referred to for examples PUSCH and PDSCH procedures.

The downlink and uplink transmissions may be organized into frames, e.g. a radio frame. In an example, each frame may be of 10 ms duration and divided into subframes of 1 ms duration. Each subframe may be further divided into multiple Orthogonal Frequency Division-Multiplexing (OFDM) symbols. The OFDM symbols may be arranged to slots within each subframe. In an example, the radio frame may include 10 subframes. One subframe may include two consecutive slots of 14 symbols with 30 kHz sub-carrier spacing. Accordingly, the radio frame may in total include 20 slots.

FIGS. 5, 6 and 7 illustrate examples of methods in accordance with at least some embodiments of the present invention. Referring to FIG. 5 the method enables a wireless network to learn about a change in mobility of a wireless device in order to cause a change of a control plane activity between the wireless device and the wireless network. Changing the control plane activity may comprise reducing a periodicity of uplink transmissions or increasing a periodicity of uplink transmissions. Changing the control plane activity by increasing periodicity of the control plane activity enables reducing DRX Active Time for the wireless device, when the wireless device applies DRX. Additionally, uplink communications resources are saved. In an example, a wireless device that follows the UE power model of TR 38.840, a long PUCCH or PUSCH transmission power consumption may be 2.5-7×higher than power consumption during monitoring of PDCCH (slot-average for FR1), while short PUCCH and SRS transmissions consume 0.3×PUSCH transmission power. Thus the power consumption during the DRX Active Time can be reduced if the wireless device observes a situation, where uplink transmissions, e.g. CSI or SRS, of the control plane activity, are not likely to provide any new information to the network. Such situations comprise at least a changed mobility of the wireless device.

Phase 502 comprises receiving, by a wireless device, from a wireless network, a configuration for at least one control plane activity towards the wireless network.

Phase 506 comprises transmitting, by the wireless device, on the basis of determining that one or more conditions for changing the transmission activity are met, assistance information for the at least one control plane activity, to the wireless network.

In an example in accordance with at least some embodiments, wherein phase 506 comprises that the one or more conditions comprise one or more of a change of a mobility of the wireless device, a change of an arrival rate of data for transmission towards the wireless network and a reception of a trigger message from the wireless network.

In an example in accordance with at least some embodiments, phase 506 comprises receiving, by the wireless device, from the wireless network, a new configuration for the at least one control plane activity; and changing, by the wireless device, on the basis of the new configuration for the at least one control plane activity, the transmission activity of the at least one control plane activity. In an example the new configuration may cause an increase of a periodicity of transmissions from the wireless device towards the wireless network, whereby the wireless device may get into a sleep mode for achieving power saving and to reduce DRX Active Time. On the other hand, the new configuration may cause a decrease of a periodicity of transmissions from the wireless device towards the wireless network, whereby the DRX Active Time of the wireless device may be increased.

In an example in accordance with at least some embodiments, phase 506 comprises receiving, by the wireless device, from the wireless network, in response to transmitting the assistance information, a new configuration for the at least one control plane activity; and changing, by the wireless device, on the basis of the new configuration for the at least one control plane activity, the transmission activity of the at least one control plane activity. In this way the wireless device may benefit from the new configuration that has been determined by the wireless network based on the assistance information. In an example the new configuration may cause an increase of a periodicity of transmissions from the wireless device towards the wireless network, whereby the wireless device may get into a sleep mode for achieving power saving and to reduce DRX Active Time. On the other hand, the new configuration may cause a decrease of a periodicity of transmissions from the wireless device towards the wireless network, whereby the DRX Active Time of the wireless device may be increased.

In an example in accordance with at least some embodiments, phase 502 comprises performing, by the wireless device, at least one of a measurement activity and a monitoring activity for the at least one control plane activity, and phase 506 comprises maintaining, by the wireless device, the at least one of the measurement activity and the monitoring activity, when the new configuration for the at least one control plane activity has been applied. Accordingly, any measurement activity and/or monitoring activity of the wireless device may be continued by the wireless device even if the new configuration would increase or decrease the periodicity of transmissions from the wireless device towards the wireless network. The increase in the periodicity of transmissions provides transmission power savings and can reduce the DRX Active Time of the wireless device while general robustness of the control plane activity is not challenged. It should be noted that applying the new configurations may cause changes to one or both of the measurement activity and the monitoring activity. Accordingly, the applying the new configuration may cause to increase or decrease a periodicity of one or both of the measurement activity and the monitoring activity. Periodicities of the measurement activity and/or monitoring activity may be associated with each other, whereby if a periodicity of the monitoring activity is decreased also the periodicity of the measurement activity is decreased. On the other hand, if a periodicity of the monitoring activity is increased also the periodicity of the measurement activity may be increased.

In an example in accordance with at least some embodiments, phase 506 comprises determining a change of a wireless channel, e.g. a radio channel, between the wireless device and the wireless network. The change of the wireless channel may be used by the wireless device to determine a change of the mobility of the wireless device. The wireless channel may be observed by the wireless device over a time period, where the change of the mobility may be determined, on the basis of measurements, e.g. CSI measurements.

In an example in accordance with at least some embodiments, phase 506 comprises determining the change of the mobility of the wireless device on the basis of a sensor. The sensor may be configured movable with the wireless device such that a movement of the wireless device causes a movement of the sensor. The sensor may be implemented using one or more gyroscopes or accelerometers. In this way measurements of the sensor may be used to determine the change of the mobility of the wireless device.

In an example in accordance with at least some embodiments, phase 506 comprises determining the change of the mobility of the wireless device from mobile to quasi-stationary or stationary, or from stationary or quasi-stationary to mobile.

In an example in accordance with at least some embodiments, phase 502 comprises that the at least one control plane activity comprises at least one of channel state information reporting, uplink sounding, power headroom reporting, reference signal received power reporting and buffer status reporting.

In an example in accordance with at least some embodiments, the control plane activity comprises channel state information reporting. The channel state information reporting comprises the wireless device transmitting CSI reports to the wireless network. The wireless device may measure downlink Channel State Information (CSI) Reference Signals (CSI-RS) and report results of the CSI-RS measurements in a CSI report on the basis of the channel state information reporting configuration. CSI reports may be transmitted by the wireless device periodically, semi-persistently or aperiodically on the basis of the state information reporting configuration. Accordingly, the CSI reports may have a certain periodicity. An example of a CSI reporting configuration is defined by CSI-ReportConfig in 3GPP TS 38.331. The report may contain information on Channel Quality Indicator, rank indicator, precoding matrix indicator, and/or Reference Signal Received Power (RSRP). The wireless device may determine a need to change the periodicity of the CSI reports based on the change of the mobility, and suggest a different periodicity for the CSI reports through the assistance information in phase 506. For example, in case the mobility of the wireless device has changed from mobile to stationary or quasi-stationary, the wireless device may determine a need to change the periodicity for the CSI reports and suggest to the wireless network to change the periodicity of the CSI reports in the assistance information in phase 506. The wireless network may cause a change of the periodicity of the CSI reports based on the assistance information from the wireless device suggesting the different periodicity for the CSI reports.

In an example in accordance with at least some embodiments, the control plane activity comprises uplink sounding. The uplink sounding comprises the wireless device transmitting SRSs to the wireless network. The SRSs may be used for uplink scheduling by the wireless network. The SRSs may be transmitted may by the wireless device periodically, semi-persistently or aperiodically on the basis of an SRS configuration. Accordingly, the SRS transmissions may have a certain periodicity. The periodic and semi-persistent SRS transmissions may be offset in time. An example of an SRS configuration is defined by SRS-Config IE in 3GPP TS 38.331. The SRS configuration defines a list of SRS-Resources and a list of SRS-ResourceSets. Each resource set defines a set of SRS-Resources. The wireless device may determine a need to change the periodicity of the SRS transmissions based on the change of the mobility, and suggest a different periodicity for the SRS transmissions through the assistance information in phase 506. For example, in case the mobility of the wireless device has changed from mobile to stationary or quasi-stationary, the wireless device may determine a need to change the periodicity for the SRS transmissions and suggest to the wireless network to change the periodicity of the SRS transmissions in the assistance information in phase 506. The wireless network may cause a change of the periodicity of the SRS transmissions based on the assistance information from the wireless device suggesting the different periodicity for the SRS transmissions.

In an example in accordance with at least some embodiments, the control plane activity comprises power headroom reporting (PHR) used by the wireless device to inform the wireless network about available a power headroom of the wireless device. The power headroom reporting comprises the wireless device reporting a power headroom value in a power headroom report to the wireless network. The power headroom report may be transmitted by the wireless device periodically on the basis of a power headroom reporting configuration. Accordingly, the power headroom reports may have a certain periodicity. An example of a power headroom reporting configuration is defined by IE PHR-Config in 3GPP TS 38.331. An example of the power headroom report is described in Section 7.7 of TS 38.213 V16.0.0 (2019-12) Physical layer procedures for control (Release 16). The power headroom value may be a difference between a nominal maximum transmit power and an estimated transmission power of the wireless device. The estimated transmission power of the wireless device may be e.g. for PUSCH or SRS transmission. The power headroom report may be triggered based on the expiry of a phr-PeriodicTimer defined by IE PHR-Config in 3GPP TS 38.331. The wireless device may determine a need to change the phr-PeriodicTimer based on the change of the mobility, and suggest a different periodicity for the PHR through the assistance information in phase 506. For example, in case the mobility of the wireless device has changed from mobile to stationary or quasi-stationary, the wireless device may determine a need to change the periodicity for the PHR and suggest the wireless network to change the phr-PeriodicTimer in the assistance information in phase 506. The wireless network may cause a change of the PHR based on the assistance information from the wireless device suggesting the different periodicity for the power headroom reports.

In an example in accordance with at least some embodiments, the control plane activity comprises buffer status reporting (BSR) used by the wireless device to inform the wireless network about available uplink data. The BSR comprises the wireless device reporting a buffer status report to the wireless network. The buffer status report may be transmitted by the wireless device periodically on the basis of a buffer status reporting configuration. Accordingly, the BSR reports may have a certain periodicity. The buffer status report may be according to Section 5.4.5 in 3GPP TS 38.321. IE BSR-Config described in 3GPP TS 38.331, defines a periodicBSR-Timer, that defines a periodicity used by the wireless device to send a periodic BSR. The periodic BSR is triggered based on the expiry of the periodicBSR-Timer, thus not based on arrival of uplink data in wireless device buffer(s). The wireless device may determine a need to change the periodicBSR-Timer based on the change of arrival rate of data for transmission towards the wireless network, i.e. for uplink transmission, and suggest a different periodicity for the BSR through the assistance information in phase 506. The wireless network may cause a change of the BSR based on the assistance information from the wireless device suggesting the different periodicity for the buffer status reports.

In an example in accordance with at least some embodiments, the control plane activity comprises reference signal received power reporting. The reference signal received power reporting may comprise a L1-RSRP (Layer 1 Reference Signal received Power) reporting in accordance with Section 5.2.1 of 3GPP TS 38.214.

In an example in accordance with at least some embodiments, the assistance information comprises at least one of a periodicity, an offset, a precoding matrix indicator (PMI) and a Channel Quality Indicator (CQI) granularity. The PMI determines a mapping of individual data streams, or layers, to antennas. Using knowledge of allowed precoding matrices, the wireless device may send a PMI indicator to the wireless network to suggest a suitable matrix.

The CQI granularity defines a frequency granularity of CQI feedback for the wireless device to the wireless network. Specifically, in Wideband feedback, the wireless device reports one wideband CQI value for the whole system bandwidth. In Subband-level feedback, the wireless device reports CQI for each subband. In wireless device selected subband feedback, the wireless device reports the position of M preferred subbands that have the highest subband CQIs and a single CQI value for these subbands.1 In periodic CQI feedback, wideband and wireless device selected subband feedback are possible. Even in the latter, the CSI feedback is very limited; the subbands are further clustered into bandwidth parts, and the wireless device reports the CI of one subband from each bandwidth part. The configurable sub-band sizes based on bandwidth size are described in Table 5.2.1.4-2 of TS 38.214 V16.3.0 (2020-09) Physical layer procedures for data (Release 16).

In an example in accordance with at least some embodiments, transmissions of assistance information and/or transmissions of a control plane activity from the wireless device, may be performed on PUCCH or PUSCH. Periodic transmissions of a control plane activity may be performed on PUSCH. Aperiodic of a control plane activity may be performed on PUCCH. Semi-persistent of a control plane activity may be performed on PUCCH. PUCCH transmissions and PUSCH transmissions may be performed a set of resources defined in a time-frequency domain physical channel.

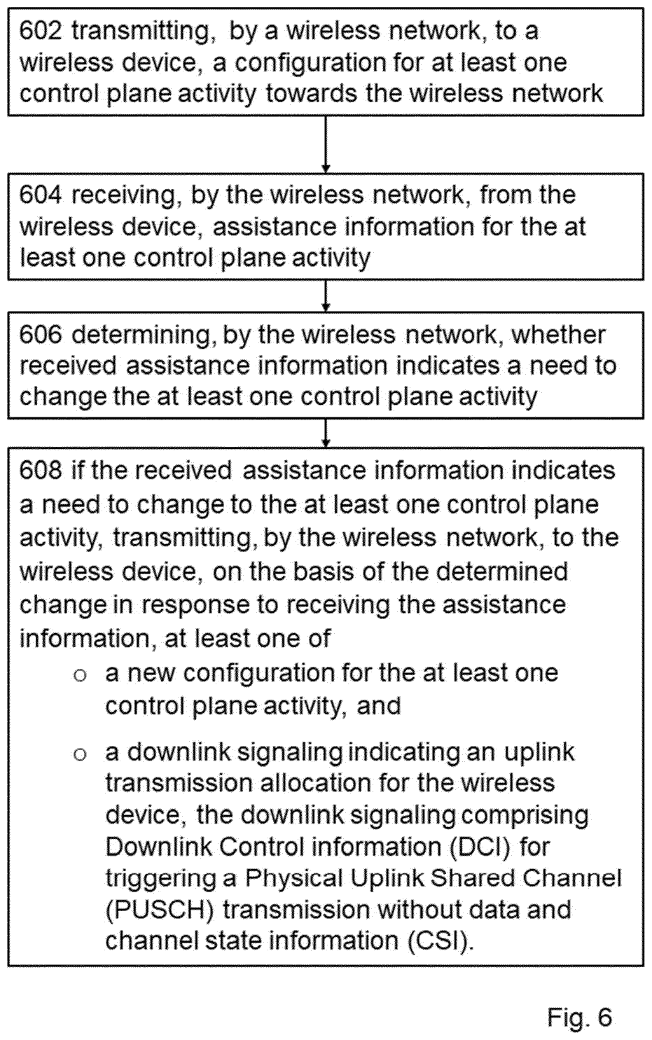

Referring to FIG. 6 the method enables a wireless device to cause a change of a control plane activity towards a wireless network. Changes to the control plane activity may comprise changing a transmission activity of the control plane activity towards the wireless network. If the wireless device applies DRX, the DRX Active Time may be reduced. Phase 602 comprises transmitting, by a wireless network, to a wireless device, a configuration for at least one control plane activity towards the wireless network.

Phase 604 comprises receiving, by the wireless network, from the wireless device, assistance information for the at least one control plane activity.

Phase 606 comprises determining, by the wireless network, on the basis of the received assistance information a need to change the at least one control plane activity. In an example, the wireless network may determine that the received assistance information indicates a need to change the at least one control plane activity.

Phase 608 comprises if the received assistance information indicates a need to change the at least one control plane activity, transmitting, by the wireless network, to the wireless device, on the basis of the determined change in response to receiving the assistance information, at least one of
a new configuration for the at least one control plane activity, and
a downlink signaling indicating an uplink transmission allocation for the wireless device, the downlink signaling comprising Downlink Control information (DCI) for triggering a Physical Uplink Shared Channel (PUSCH) transmission without data and channel state information (CSI). The new configuration provides that the wireless device may change the control plane activity between the wireless device and the wireless network. The downlink signaling may trigger the wireless device to send assistance information for the at least one control plane activity to the wireless network, whereby the wireless network may be caused to transmit the new configuration to the wireless device. Alternatively or additionally, the downlink signaling may cause the wireless device to skip some, e.g. one or more, uplink transmissions according to a control plane activity configuration currently applied by the wireless device.

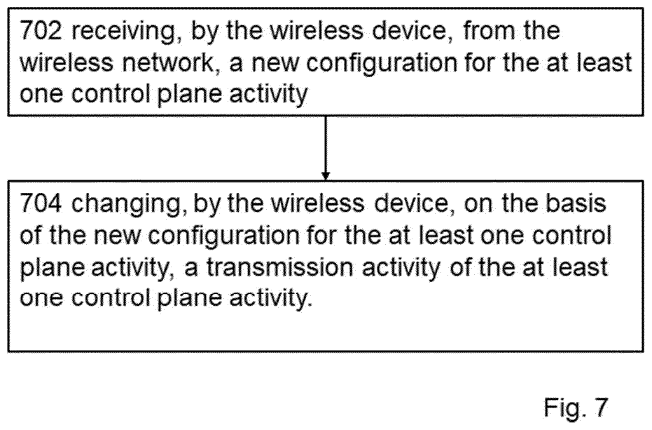

Referring to FIG. 7 the method enables a wireless device to apply changes to a control plane activity towards a wireless network.

Phase 702 comprises receiving, by the wireless device, from the wireless network, a new configuration for the at least one control plane activity.

Phase 704 comprises changing, by the wireless device, on the basis of the new configuration for the at least one control plane activity, the transmission activity of the at least one control plane activity.

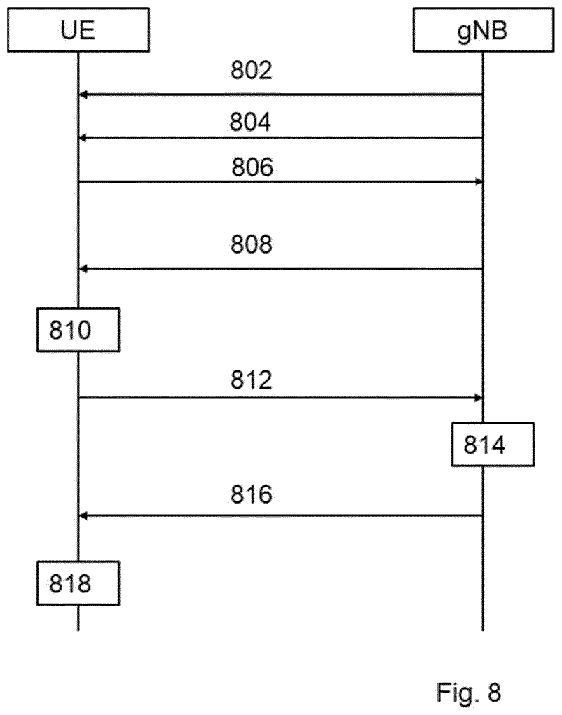

FIG. 8 illustrates an example of a sequence in accordance with at least some embodiments of the present invention. The sequence may be performed by a user equipment (UE) and a gNB. In the sequence, an example of a control plane activity comprises performing Channel State Information-Reference Signal (CSI-RS) measurements and reporting. However, it should be noted that the sequence may be applied also to other embodiments and control plane activities. The sequence provides communications of assistance information from the UE configured to perform a control plane activity comprising transmission activity toward the gNB, whereby the UE may be caused to change the transmission activity such that power saving may be achieved by reducing transmissions from the UE to the gNB. When the UE applies DRX, the DRX Active Time may be increased.

Phase 802 comprises the UE receiving from the gNB a configuration for a CSI-RS measurements and reporting. Phase 804 comprises the UE measuring CSI-RS transmitted by the gNB.

Phase 806 comprises the UE transmitting a CSI (Channel State Information) report.

Phase 808 comprises the UE measuring CSI-RS transmitted by the gNB.

Phase 810 comprises the UE determining, a change of a mobility of the UE.

Phase 812 comprises the UE transmitting on the basis of the determined change, assistance information for the at least one control plane activity, to the gNB.

Phase 814 comprises the gNB determining on the basis of the received assistance information a need to change the at least one control plane activity. In an example, the gNB may determine that the received assistance information indicates a need to change the at least one control plane activity.

Phase 816 comprises if the received assistance information indicates a need to change the at least one control plane activity, transmitting, by the gNB, to the UE, on the basis of the determined change in response to receiving the assistance information, at least one of
a new configuration for the at least one control plane activity, and
a downlink signaling indicating an uplink transmission allocation for the UE, the downlink signaling comprising Downlink Control information (DCI) for triggering a Physical Uplink Shared Channel (PUSCH) transmission without data and channel state information (CSI).

In an example, phase 816 comprises receiving, by the UE, a downlink signaling indicating an uplink transmission allocation for the UE and determining, by the UE, that the downlink signaling comprises Downlink Control information (DCI) for triggering a Physical Uplink Shared Channel (PUSCH) transmission without data and channel state information (CSI), and phase 818 comprises omitting, by the UE, at least one uplink transmission in accordance with the control plane activity in response to the DCI received in phase 816. In this way the UE is enabled to skip some, e.g. one or more, uplink transmissions according to the control plane activity configuration. On the other hand, in phase 816, the UE may receive, a trigger message that may cause the UE to transmit a Physical Uplink Shared Channel (PUSCH) transmission without data and channel state information (CSI). The trigger message may be downlink signaling indicating an uplink transmission allocation for the UE. The downlink signaling may comprise Downlink Control information (DCI) for triggering a Physical Uplink Shared Channel (PUSCH) transmission without data and channel state information (CSI). In this way, the gNB may use the trigger message to cause the UE to send assistance information for the at least one control plane activity to the gNB in accordance to described with phase 812 and phase 506 of FIG. 5 for example.

In an example, phase 818 comprises the UE changing, on the basis of the new configuration for the at least one control plane activity, received in phase 816, the transmission activity of the at least one control plane activity. In this way the UE may increase a periodicity of transmissions from the UE towards the gNB, or the UE may decrease a periodicity of transmissions from the UE towards the gNB.

In an example, phase 816 comprises, the gNB transmitting to the UE a trigger message that causes a Physical Uplink Shared Channel (PUSCH) transmission without data and channel state information (CSI). The trigger message may be downlink signaling indicating an uplink transmission allocation for the UE. The downlink signaling may comprise Downlink Control information (DCI) for triggering a Physical Uplink Shared Channel (PUSCH) transmission without data and channel state information (CSI). In an example, the DCI may be an activation DCI triggering data-less and CSI-less PUSCH transmission, which causes the UE to change the CSI reporting. Accordingly, in phase 816, the UE may receive a DCI with CRC scrambled with C-RNTI or Configured Scheduling RNTI (CS-RNTI). Then, the UE may check the DCI if UL-SCH indicator is ‘0’ and if CSI request field is set to zero. If yes, the UE may determine an error case. In accordance with Section 7.3.1.1.2 of 3GPP TS 38.212 V16.3.0 (2020-09) Multiplexing and channel coding (Release 16):
UL-SCH indicator—0 or 1 bit as follows
   0 bit if the number of scheduled PUSCH indicated by the Time domain resource assignment field is larger than 1;
   1 bit otherwise. A value of “1” indicates UL-SCH shall be transmitted on the PUSCH and a value of “0” indicates UL-SCH shall not be transmitted on the PUSCH. Except for DCI format 0_1 with CRC scrambled by SP-CSI-RNTI, a UE is not expected to receive a DCI format 0_1 with UL-SCH indicator of “0” and CSI request of all zero(s).

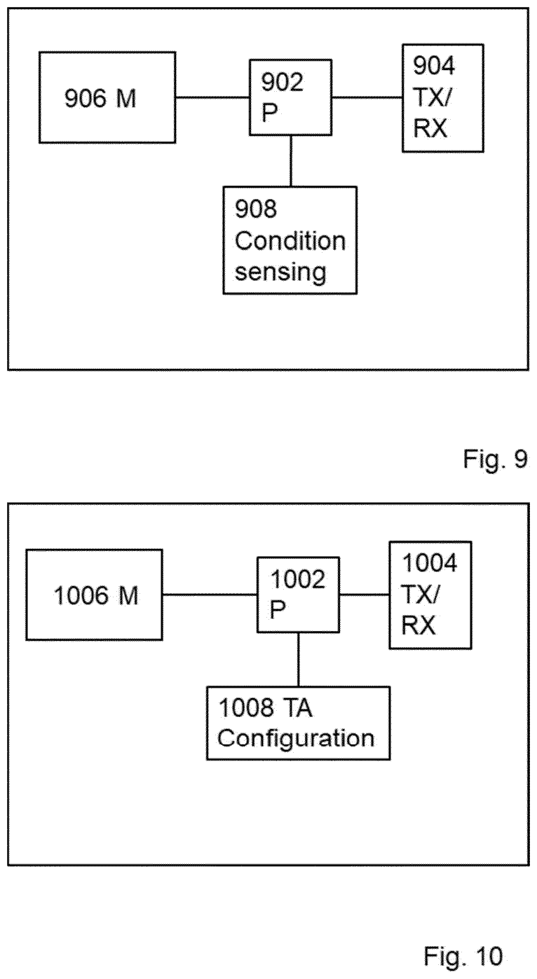

FIG. 9 illustrates an example of an apparatus in accordance with at least some embodiments of the present invention. The apparatus may be a wireless device or UE or a part of a wireless device or UE.

The apparatus comprises a processor 902 and a transceiver 904. The processor is operatively connected to the transceiver for controlling the transceiver. The apparatus may comprise a memory 906. The memory may be operatively connected to the processor. It should be appreciated that the memory may be a separate memory or included to the processor and/or the transceiver.

In an example, the apparatus comprises a condition sensing block 908 connected operatively to the processor. The condition sensing block may provide carrying out functionalities related to determining one or more conditions for changing the transmission activity and generating assistance information for the wireless network.

FIG. 10 illustrates an example of an apparatus in accordance with at least some embodiments of the present invention. The apparatus may be a gNB or access node, or a part of a gNB or access node.

The apparatus comprises a processor 1002 and a transceiver 1004. The processor is operatively connected to the transceiver for controlling the transceiver. The apparatus may comprise a memory 1006. The memory may be operatively connected to the processor. It should be appreciated that the memory may be a separate memory or included to the processor and/or the transceiver.

In an example, the apparatus comprises a control plane activity (CPA) block 1008 connected operatively to the processor. The control plane activity block may host a control plane entity of a control plane activity for carrying out functionalities of the control plane activity and causing one or more changes of the configuration of a control plane activity.

According to an embodiment, the processor is configured to control the transceiver and/or to perform one or more functionalities described with a method according to an embodiment.

### EXAMPLES

1. A method comprising:
receiving, by a wireless device, from a wireless network, a configuration for at least one control plane activity towards the wireless network,
transmitting, by the wireless device, on the basis of determining that one or more conditions for changing the transmission activity are met, assistance information for the at least one control plane activity, to the wireless network

2. The method according to example 1, wherein the one or more conditions comprise one or more of a change of a mobility of the wireless device, a change of an arrival rate of data for transmission towards the wireless network and a reception of a trigger message from the wireless network.

3. The method according to example 1 or 2, comprising:
receiving, by the wireless device, from the wireless network, a new configuration for the at least one control plane activity;
changing, by the wireless device, on the basis of the new configuration for the at least one control plane activity, the transmission activity of the at least one control plane activity.

4. The method according to example 3, comprising:
performing, by the wireless device, at least one of a measurement activity and a monitoring activity for the at least one control plane activity; and
maintaining, by the wireless device, the at least one of the measurement activity and the monitoring activity, when the new configuration for the at least one control plane activity has been applied.

5. The method according to any of examples 1 to 4, comprising:
receiving, by the wireless device, a downlink signaling indicating an uplink transmission allocation for the wireless device;
determining, by the wireless device, that the downlink signaling comprises Downlink Control information (DCI) for triggering a Physical Uplink Shared Channel (PUSCH) transmission without data and channel state information (CSI);
omitting, by the wireless device, at least one uplink transmission in accordance with the control plane activity in response to the DCI.

6. The method according to any of examples 1 to 5, wherein the at least one control plane activity comprises at least one of channel state information reporting, uplink sounding, power headroom reporting, reference signal received power reporting or buffer status reporting.

7. A method comprising:
transmitting, by a wireless network, to a wireless device, a configuration for at least one control plane activity towards the wireless network;
receiving, by the wireless network, from the wireless device, assistance information for the at least one control plane activity.

8. The method according to example 7, comprising:
determining, by the wireless network, to change the at least one control plane activity; and
transmitting, by the wireless network, to the wireless device, in response to receiving the assistance information, at least one of
   a. a new configuration for the at least one control plane activity, and/or
   b. a downlink signaling indicating an uplink transmission allocation for the wireless device, the downlink signaling comprising Downlink Control information (DCI) for triggering a Physical Uplink Shared Channel (PUSCH) transmission without data and channel state information (CSI).

9. The method according to example 7 or 8, wherein the at least one control plane activity comprises at least one of channel state information reporting, uplink sounding, power headroom reporting, reference signal received power reporting or buffer status reporting.

10. An apparatus comprising:
means for receiving, from a wireless network, a configuration for at least one control plane activity towards the wireless network; and
means for transmitting, on the basis of determining that one or more conditions for changing the transmission activity are met, assistance information for the at least one control plane activity, to the wireless network.

11. The apparatus according to claim 10, wherein the one or more conditions comprise one or more of a change of a mobility of the wireless device, a change of an arrival rate of data for transmission towards the wireless network and a reception of a trigger message from the wireless network.

12. The apparatus according to example 10 or 11, comprising:
means for receiving from the wireless network, a new configuration for the at least one control plane activity;
means for changing, on the basis of the new configuration for the at least one control plane activity, the transmission activity of the at least one control plane activity.

13. The apparatus according to example 12, comprising:
means for performing at least one of a measurement activity and a monitoring activity for the at least one control plane activity; and
means for maintaining the at least one of the measurement activity and the monitoring activity, when the new configuration for the at least one control plane activity has been applied.

14. The apparatus according to any of examples 10 to 13, comprising:
means for receiving a downlink signaling indicating an uplink transmission allocation for the apparatus;
means for determining that the downlink signaling comprises Downlink Control information (DCI) for triggering a Physical Uplink Shared Channel (PUSCH) transmission without data and channel state information (CSI);
means for omitting at least one uplink transmission in accordance with the control plane activity in response to the DCI.

15. The apparatus according to any of examples 10 to 14, wherein the at least one control plane activity comprises at least one of channel state information reporting, uplink sounding, power headroom reporting, reference signal received power reporting and buffer status reporting.

16. An apparatus comprising:
means for transmitting, to a wireless device, a configuration for at least one control plane activity towards the apparatus;
means for receiving from the wireless device, assistance information for the at least one control plane activity.

17. The apparatus according to example 16, comprising:
means for determining to change the at least one control plane activity; and
means for transmitting to the wireless device, in response to receiving the assistance information, at least one of
   a. a new configuration for the at least one control plane activity, and/or
   b. a downlink signaling indicating an uplink transmission allocation for the wireless device, the downlink signaling comprising Downlink Control information (DCI) for triggering a Physical Uplink Shared Channel (PUSCH) transmission without data and channel state information (CSI).

18. The apparatus according to example 16 or 17, wherein the at least one control plane activity comprises at least one of channel state information reporting, uplink sounding, power headroom reporting, reference signal received power reporting and buffer status reporting.

19. An apparatus comprising:
one or more processors, and memory storing instructions that, when executed by the one or more processors, the apparatus is caused to:
receive, from a wireless network, a configuration for at least one control plane activity towards the wireless network;
transmit, on the basis of determining that one or more conditions for changing the transmission activity are met, assistance information for the at least one control plane activity, to the wireless network.

20. The apparatus according to example 19, wherein the one or more conditions comprise one or more of a change of a mobility of the wireless device, a change of an arrival rate of data for transmission towards the wireless network and a reception of a trigger message from the wireless network.

21. The apparatus according to example 19 or 20, caused to:
receive from the wireless network, a new configuration for the at least one control plane activity;
change, on the basis of the new configuration for the at least one control plane activity, the transmission activity of the at least one control plane activity.

22. The apparatus according to example 21, caused to:
perform at least one of a measurement activity and a monitoring activity for the at least one control plane activity; and
maintain the at least one of the measurement activity and the monitoring activity, when the new configuration for the at least one control plane activity has been applied.

23. The apparatus according to any of examples 19 to 22, caused to:
receive a downlink signaling indicating an uplink transmission allocation for the apparatus;
determine that the downlink signaling comprises Downlink Control information (DCI) for triggering a Physical Uplink Shared Channel (PUSCH) transmission without data and channel state information (CSI);
omit at least one uplink transmission in accordance with the control plane activity in response to the DCI.

24. The apparatus according to any of examples 19 to 23, wherein the at least one control plane activity comprises at least one of channel state information reporting, uplink sounding, power headroom reporting, reference signal received power reporting and buffer status reporting.

25. An apparatus comprising:
one or more processors, and memory storing instructions that, when executed by the one or more processors, the apparatus is caused to:
transmit, to a wireless device, a configuration for at least one control plane activity towards the apparatus;
receive from the wireless device, assistance information for the at least one control plane activity.

26. The apparatus according to example 25, wherein the apparatus is caused to:
determine to change the at least one control plane activity; and
to the wireless device, in response to receiving the assistance information, at least one of
   a. a new configuration for the at least one control plane activity, and/or
   b. a downlink signaling indicating an uplink transmission allocation for the wireless device, the downlink signaling comprising Downlink Control information (DCI) for triggering a Physical Uplink Shared Channel (PUSCH) transmission without data and channel state information (CSI).

27. The apparatus according to example 25 or 26, wherein the at least one control plane activity comprises at least one of channel state information reporting, uplink sounding, power headroom reporting, reference signal received power reporting and buffer status reporting.

28. A computer program comprising computer readable program code means adapted to perform at least the following:
receiving, by a wireless device, from a wireless network, a configuration for at least one control plane activity towards the wireless network;
transmitting, by the wireless device, on the basis of determining that one or more conditions for changing the transmission activity are met, assistance information for the at least one control plane activity, to the wireless network

29. The computer program according to example 28, wherein the one or more conditions comprise one or more of a change of a mobility of the wireless device, a change of an arrival rate of data for transmission towards the wireless network and a reception of a trigger message from the wireless network.

30. The computer program according to example 28 or 29, comprising:
receiving, by the wireless device, from the wireless network, a new configuration for the at least one control plane activity;
changing, by the wireless device, on the basis of the new configuration for the at least one control plane activity, the transmission activity of the at least one control plane activity.

31. The computer program according to example 30, comprising:
performing, by the wireless device, at least one of a measurement activity and a monitoring activity for the at least one control plane activity; and
maintaining, by the wireless device, the at least one of the measurement activity and the monitoring activity, when the new configuration for the at least one control plane activity has been applied.

32. The computer program according to any of examples 28 to 31, comprising:
receiving, by the wireless device, a downlink signaling indicating an uplink transmission allocation for the wireless device;
determining, by the wireless device, that the downlink signaling comprises Downlink Control information (DCI) for triggering a Physical Uplink Shared Channel (PUSCH) transmission without data and channel state information (CSI);
omitting, by the wireless device, at least one uplink transmission in accordance with the control plane activity in response to the DCI.

33. The computer program according to any of examples 28 to 32, wherein the at least one control plane activity at least one of channel state information reporting, uplink sounding, power headroom reporting, reference signal received power reporting and buffer status reporting.

34. A computer program comprising computer readable program code means adapted to perform at least the following:
transmitting, by a wireless network, to a wireless device, a configuration for at least one control plane activity towards the wireless network;
receiving, by the wireless network, from the wireless device, assistance information for the at least one control plane activity.

35. The computer program according to example 34, comprising:
determining, by the wireless network, to change the at least one control plane activity; and
transmitting, by the wireless network, to the wireless device, in response to receiving the assistance information, at least one of
   a. a new configuration for the at least one control plane activity, and/or
   b. a downlink signaling indicating an uplink transmission allocation for the wireless device, the downlink signaling comprising Downlink Control information (DCI) for triggering a Physical Uplink Shared Channel (PUSCH) transmission without data and channel state information (CSI).

36. The computer program according to example 34 or 35, wherein the at least one control plane activity comprises at least one of channel state information reporting, uplink sounding, power headroom reporting, reference signal received power reporting and buffer status reporting.

37. The apparatus, method or computer program according to any of the examples 1 to 36, wherein the assistance information comprises at least one of a timer, an offset, a precoding matrix indicator (PMI) and a channel quality indicator (CQI) granularity.

Embodiments may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialized circuits such as field programmable gate arrays FPGA, application specify circuits ASIC, signal processing devices and other devices. References to computer readable program code means, computer program, computer instructions, program instructions, instructions, computer code etc. should be understood to express software for a programmable processor firmware such as the programmable content of a hardware device as instructions for a processor or configured or configuration settings for a fixed function device, gate array, programmable logic device, etc.

Although the above examples describe embodiments of the invention operating within a wireless device or a gNB, it would be appreciated that the invention as described above may be implemented as a part of any apparatus comprising a circuitry in which radio frequency signals are transmitted and/or received. Thus, for example, embodiments of the invention may be implemented in a mobile phone, in a base station, in a computer such as a desktop computer or a tablet computer comprising radio frequency communication means (e.g. wireless local area network, cellular radio, etc.).

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules, field-programmable gate arrays (FPGA), application specific integrated circuits (ASIC), microcontrollers, microprocessors, a combination of such modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analogue and/or digital circuitry) and
(b) combinations of hardware circuits and software, such as (as applicable):
   (i) a combination of analogue and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1-14. (canceled)

15. A method comprising:
receiving, by a wireless device, from a wireless network, a configuration for at least one control plane activity comprising a transmission activity towards the wireless network;
transmitting, by the wireless device, on the basis of determining that one or more conditions for changing the transmission activity are met, assistance information for the at least one control plane activity, to the wireless network.

16. The method according to claim 15, wherein the one or more conditions comprise one or more of a change of a mobility of the wireless device, a change of an arrival rate of data for transmission towards the wireless network and a reception of a trigger message from the wireless network.

17. The method according to claim 15, comprising:
receiving, by the wireless device, from the wireless network, a new configuration for the at least one control plane activity;
changing, by the wireless device, on the basis of the new configuration for the at least one control plane activity, the transmission activity of the at least one control plane activity.

18. The method according to claim 17, comprising:
performing, by the wireless device, at least one of a measurement activity and a monitoring activity for the at least one control plane activity; and
maintaining, by the wireless device, the at least one of the measurement activity and the monitoring activity, when the new configuration for the at least one control plane activity has been applied.

19. The method according to claim 15, comprising:
receiving, by the wireless device, a downlink signaling indicating an uplink transmission allocation for the wireless device;
determining, by the wireless device, that the downlink signaling comprises Downlink Control information (DCI) for triggering a Physical Uplink Shared Channel (PUSCH) transmission without data and channel state information (CSI);
omitting, by the wireless device, at least one uplink transmission in accordance with the control plane activity in response to the DCI.

20. A method comprising:
transmitting, by a wireless network, to a wireless device, a configuration for at least one control plane activity towards the wireless network;
receiving, by the wireless network, from the wireless device, assistance information for the at least one control plane activity;
determining, by the wireless network, on the basis of the received assistance information a need to change the at least one control plane activity; and
if the received assistance information indicates a need to change the at least one control plane activity, transmitting, by the wireless network, to the wireless device, on the basis of the determined change in response to receiving the assistance information, at least one of
a new configuration for the at least one control plane activity, and
a downlink signaling indicating an uplink transmission allocation for the wireless device, the downlink signaling comprising Downlink Control information (DCI) for triggering a Physical Uplink Shared Channel (PUSCH) transmission without data and channel state information (CSI).

21. The method according to claim 20, wherein the at least one control plane activity comprises at least one of channel state information reporting, uplink sounding, power headroom reporting, reference signal received power reporting and buffer status reporting.

22. The method according to claim 20, wherein the assistance information comprises at least one of a periodicity, an offset, a precoding matrix indicator (PMI) and a channel quality indicator (CQI) granularity.

23. An apparatus comprising:
one or more processors, and memory storing instructions that, when executed by the one or more processors, the apparatus is caused to:
receive, from a wireless network, a configuration for at least one control plane activity towards the wireless network;
transmit, on the basis of determining that one or more conditions for changing the transmission activity are met, assistance information for the at least one control plane activity, to the wireless network.

24. An apparatus comprising:
one or more processors, and memory storing instructions that, when executed by the one or more processors, the apparatus is caused to:
transmit, to a wireless device a configuration for at least one control plane activity towards the apparatus;
receive from the wireless device, assistance information for the at least one control plane activity.
